(19) United States
(12) Patent Application Publication
(10) Pub. No.: US 2020/0338825 A1
(43) Pub. Date: Oct. 29, 2020

(54) COMPLIANT TRANSFUSION ROLLER FOR SELECTIVE DEPOSITION BASED ADDITIVE MANUFACTURING SYSTEM

(71) Applicant: Evolve Additive Solutions, Inc., Minnetonka, MN (US)

(72) Inventors: James W. Comb, Hamel, MN (US); Chris Counts, Crystal, MN (US)

(21) Appl. No.: 16/958,907

(22) PCT Filed: Dec. 28, 2017
(86) PCT No.: PCT/US2018/067910

§ 371 Date: Jun. 29, 2020

Related U.S. Application Data
(60) Provisional application No. 62/612,101, filed on Dec. 29, 2017.

(51) Int. Cl. B29C 64/218; B33Y 30/00; G03G 15/22; B29C 64/295

(52) U.S. Cl. CPC B29C 64/218; B33Y 30/00; B33Y 50/02; B29C 64/295; G03G 15/224

(57) ABSTRACT

A selective-deposition-based additive manufacturing system (10) includes a transfer medium (24) configured to receive the layers (22) from an imaging engine (12), a heater (72) configured to heat the layers (22) on the transfer medium (24), and a layer transfusion assembly (20) that includes a build platform (28), and is configured to transfuse the heated layers (22) onto the build platform (28) in a layer-by-layer manner to print a three-dimensional part (22). The transfusion assembly (20) includes a nip roller (320) configured to deform when transfusing the heated imaged layers (22) to reduce deformation of the layers (22).

### BACKGROUND

The present disclosure relates to additive manufacturing systems for building three-dimensional (3D) parts. In particular, the present disclosure relates to additive manufacturing systems and processes for building 3D parts and support structures using an imaging process, such as electrostatography in a selective deposition based additive manufacturing system.

Additive manufacturing is generally a process in which a three-dimensional (3D) object is manufactured based on a computer image of the object. A basic operation of an additive manufacturing system consists of slicing a three-dimensional computer image into thin cross sections, translating the result into two-dimensional position data, and feeding the data to control equipment which manufacture a three-dimensional structure in a layer wise manner using one or more additive manufacturing techniques. Additive manufacturing entails many different approaches to the method of fabrication, including fused deposition modeling, ink jetting, selective laser sintering, powder/binder jetting, electron-beam melting, electrophotographic imaging, and stereolithographic processes.

In an electrophotographic 3D printing process, each slice of the digital representation of the 3D part and its support structure is printed or developed from powder materials using an electrophotographic engine. The electrophotographic engine generally operates in accordance with 2D electrophotographic printing processes, using charged powder materials that are formulated for use in building a 3D part (e.g., a polymeric toner material). The electrophotographic engine typically uses a support drum that is coated with a photoconductive material layer, where latent electrostatic images are formed by electrostatic charging following image-wise exposure of the photoconductive layer by an optical source. (Alternatively, an image may be formed using ionography by direct-writing electrons or ions onto a dialectric, and eliminating the photoconductor, all within the scope of the present invention and within the use of the electrophotography terminology as used herein). The latent electrostatic images are then moved to a developing station where the polymeric toner is applied to charged areas, or alternatively to discharged areas of the photoconductive insulator to form the layer of the charged powder material representing a slice of the 3D part. The developed layer is transferred to a transfer medium, from which the layer is transfused to previously printed layers with heat and/or pressure to build the 3D part.

In transfusing layers to previously printed layers, a nip or transfusion roller is commonly used to apply pressure (and optionally heat) to the transfer medium. Electrophotography-based 3D printing systems that utilize a roller for this purpose are described in U.S. Patent Application Publication Nos. 2015/0266237, wherein the nip roller is shown and described as a non-compliant cylinder and pressure of the cylinder against the top-of-part causes deformation of the part during transfusion.

In addition to the aforementioned commercially available additive manufacturing techniques, a novel additive manufacturing technique has emerged, where particles are first selectively deposited in an imaging process, forming a layer corresponding to a slice of the part to be made; the layers are then bonded to each other, forming a part. This is a selective deposition process, in contrast to, for example, selective sintering, where the imaging and part formation happens simultaneously. The imaging step in a selective deposition process can be done using electrophotography. In two-dimensional (2D) printing, electrophotography (i.e., xerography) is a popular technology for creating 2D images on planar substrates, such as printing paper. Electrophotography systems include a conductive support drum coated with a photoconductive material layer, where latent electrostatic images are formed by charging and then image-wise exposing the photoconductive layer by an optical source. The latent electrostatic images are then moved to a developing station where toner is applied to charged areas of the photoconductive insulator to form visible images. The formed toner images are then transferred to substrates (e.g., printing paper) and affixed to the substrates with heat or pressure.

### SUMMARY

An aspect of the present disclosure is directed to a selective deposition-based additive manufacturing system for printing a 3D part. The selective deposition-based additive manufacturing system includes an electrostatographic imaging engine configured to develop an imaged layer of a powder material, a movable build platform, and a transfer medium configured to receive the imaged layer from the imaging engine, and to convey the received imaged layer. The system also includes a heater configured to heat the imaged layer on the transfer medium, and a transfusion element configured to transfer the heated imaged layer conveyed by the transfer medium onto the movable build platform by pressing the heated imaged layer between the transfer medium and the moveable build platform, and a cooling unit configured to actively cool the transferred layer. In exemplary embodiments, the transfusion element includes a compliant nip roller configured to deform when pressing the heated imaged layer to any previously transferred layers. Transfusion elements can also include a platform that moves in X and Z directions, a medium such as a belt which engages the nip roller, one or more heaters, and/or other optional components.

Another aspect of the present disclosure is directed to a selective deposition-based additive manufacturing system for printing a 3D part, where the selective deposition-based additive manufacturing system includes an electrostatographic imaging engine configured to develop imaged layers of a thermoplastic-based powder, a movable build platform, and a rotatable transfer belt having a transfer surface and an opposing contact surface. The transfer surface is configured to receive the imaged layers from the imaging engine in a successive manner, and to convey the received image layers to the build platform in a successive manner. The system also includes a heater configured to heat the imaged layers on the transfer surface in a successive manner, a nip roller configured to transfuse the heated imaged layers conveyed by the transfer medium in a successive manner onto the movable build platform by engaging and rolling across the contact surface of the rotatable belt, and a cooling unit configured to actively cool the transfused layers in a successive manner. In exemplary embodiments, the nip roller is configured to deform when pressing the heated imaged layers onto the top-of-part.

### Definitions

Unless otherwise specified, the following terms as used herein have the meanings provided below:

The terms “transfusion”, “transfuse”, “transfusing”, and the like refer to the adhesion of layers with the use of heat and pressure, where polymer molecules of the layers at least partially interdiffuse.

The term “transfusion pressure” refers to a pressure applied during a transfusion step, such as when transfusing layers of a 3D part together.

The term “deformation temperature” of a 3D part refers to a temperature at which the 3D part softens enough such that a subsequently-applied transfusion pressure, such as during a subsequent transfusion step, overcomes the structural integrity of the 3D part, thereby deforming the 3D part.

Unless otherwise specified, temperatures referred to herein are based on atmospheric pressure (i.e. one atmosphere).

Directional orientations such as “above”, “below”, “top”, “bottom”, and the like are made with reference to a direction along a printing axis of a 3D part. In the embodiments in which the printing axis is a vertical z-axis, the layer-printing direction is the upward direction along the vertical z-axis. In these embodiments, the terms “above”, “below”, “top”, “bottom”, and the like are based on the vertical z-axis. However, in embodiments in which the layers of 3D parts are printed along a different axis, the terms “above”, “below”, “top”, “bottom”, and the like are relative to the given axis.

The term “selective deposition” refers to an additive manufacturing technique where one or more layers of particles are fused to previously deposited layers utilizing heat and pressure over time where the particles fuse together to form a layer of the part and also fuse to the previously printed layer.

The term “electrostatography” refers to the formation and utilization of latent electrostatic charge patterns to form an image of a layer of a part, a support structure or both on a surface. Electrostatography includes, but is not limited to, electrophotography where optical energy is used to form the latent image, ionography where ions are used to form the latent image and/or electron beam imaging where electrons are used to form the latent image.

The term “providing”, such as for “providing a material” and the like, when recited in the claims, is not intended to require any particular delivery or receipt of the provided item. Rather, the term “providing” is merely used to recite items that will be referred to in subsequent elements of the claim(s), for purposes of clarity and ease of readability.

The terms “about” and “substantially” are used herein with respect to measurable values and ranges due to expected variations known to those skilled in the art (e.g., limitations and variabilities in measurements).

### BRIEF DESCRIPTION OF THE DRAWINGS

FIG. 1 is a front view of an example selective deposition-based additive manufacturing system of the present disclosure.

FIG. 2 is an expanded view of a prior art layer transfusion assembly.

FIG. 3 is an expanded view of a layer transfusion assembly of the electrophotography-based additive manufacturing system shown in FIG. 1, similar to the assembly shown in FIG. 2, and having a compliant nip roller configured to deform when pressing a heated imaged layer.

FIGS. 4-6 are illustrations of the compliant nip roller shown in FIG. 3.

FIG. 7 is a schematic illustration of the nip roller shown in FIGS. 3-6 of the layer transfusion assembly pressed against a top surface of a 3D part, illustrating deformation of the nip roller.

FIG. 8 illustrates deformation of complaint nip rollers, under various pressures, for different material elastic moduli.

FIG. 9 is an expanded view of an alternative layer transfusion assembly of the electrophotography-based additive manufacturing system, having separate transfusion and release rollers, and a post heater, and which utilizes the compliant nip roller.

FIG. 10 is an expanded view of another alternative layer transfusion assembly of the electrophotography-based additive manufacturing system, having separate transfusion and release rollers, and a belt with a high thermal conductivity and heat capacity, and which utilizes the compliant nip roller.

FIG. 11 is an expanded view of yet another example embodiment of an alternative layer transfusion assembly of the electrophotography-based additive manufacturing system, having separate transfusion and release rollers, a belt with a high thermal conductivity and heat capacity, and a contact cooling unit, and which utilizes the compliant nip roller.

FIG. 12 is a schematic front view of still another example alternative layer transfusion assembly, configured for performing pre-sintering, and which utilizes the compliant nip roller.

FIG. 13 is a schematic front view of an exemplary transfusion assembly of a system for performing layer transfusion steps with the developed layers with planishing, in accordance with some exemplary embodiments of the present disclosure.

### DETAILED DESCRIPTION

The present disclosure is directed to a layer transfer technique for printing 3D parts and support structures in a layer-by-layer manner, where each layer is printed from a part or support material in a thermally-controlled manner. The layer transfer technique is performed with an imaging system, such as a selective deposition-based additive manufacturing system. For example, each layer may be developed or otherwise imaged using electrostatography and carried from an electrostatography engine by a transfer medium (e.g., a rotatable belt or drum). The layer is then transferred to a build platform to print the 3D part (or support structure) in a layer-by-layer manner, where the successive layers are transfused together to produce the 3D part.

In comparison to 2D printing, in which developed toner particles can be electrostatically transferred to printing paper by placing an electrical potential through the printing paper using a solid metal transfer roller, the multiple printed layers in a 3D environment effectively prevents the electrostatic transfer of part and support materials after a given number of layers are printed (e.g., about 15 layers). Instead, in 3D printing using systems such as disclosed in the present disclosure, a layer retained by the transfer medium is heated to an elevated transfer temperature. The heated layer is then pressed against a previously-printed top-of-part layer of a 3D part under construction on a build platform (or in the case of an initial layer, to the build platform itself) by a transfusion roller, referred to as a nip roller. The roller releases the layer from the transfer medium and joins it to the top-of-part layer, thereby transfusing the layers together (i.e., a transfusion step). The transfusion step allows numerous layers of 3D parts and support structures to be built vertically, beyond what is otherwise achievable via electrostatic transfers.

In exemplary embodiments disclosed herein, the nip roller is a compliant roller having a material which will deform under pressure. Compression and deformation of the roller against the top-of-part enables application of force against the top-of-part while allowing the part to remain flat, thus preventing damage to the layers of the part during transfusion. The roller deformation desirably also creates additional contact between the roller and the top-of-part along a length of the roller surface in the direction of its rotation (herein referred to as the “nip length”). A contact area on the surface of the roller is created along the nip length, whose area of contact increases the dwell time of the roller against the part surface as compared to a typical contact line that would occur if a round non-compliant roller was pressed along the relatively flat top-of-part at a pressure low enough to avoid deformation of the part. In 2D printing, deformation is not a concern because there is only a single layer; the image is not sequentially contacted with additional toner images. The disclosed compliant roller transfusion assemblies thus allow longer compression or dwell times than would conventionally be feasible without damaging the part. The duration of compression improves bonding of the new layer to the build stack while it is in a warm state. Examples of 3D printing systems in which disclosed concepts and embodiments can be implemented are described, for example, in U.S. Patent Application Publication No. 2013/0186549 to Comb et al. entitled LAYER TRANSFUSION FOR ADDITIVE MANUFACTURING, which is herein incorporated by reference in its entirety.

In various disclosed embodiments, pressure is applied by a pressing component, such as a nip roller, to a portion of a heated layer for a dwell time. The dwell time is affected by a number of factors, including the feed rate of a transfer belt with faster feed rates resulting in shorter dwell times, a transfer belt durometer, a transfer roller diameter, a transfer roller durometer, a pressure profile, etc. To control the dwell time these various factors can be selected or controlled. For example, the durometer of the nip roller can be selected to increase or decrease the dwell time. For durometer controlled dwell times, generally the softer the durometer, the greater the length of the surface of a transfer layer over which the pressure is applied by the roller or pressing component. Alternatively, a controller can change the belt speed or adjust the z-height of a build platform to change the nip pressure.

In some instances, a single pass dwell time is on the order of 100× too short to result in full sintering. Active belt cooling can be used to counteract the temperature diffusion from the top of part to the belt/layer interface, allowing a greater maximum dwell time. The peak pressure also affects the dwell time of the pressing component. For example, as the pressure increases, the belt and exterior surface of the transfer roller flatten and extend the length of the surface of the layer that is pressed by the transfer roller and transfer belt. As the pressure decreases, the length of the surface of the layer that is pressed by the transfer roller and belt is reduced.

In exemplary embodiments, the dwell time is controlled using any of the above-mentioned factors. In particular, in some disclosed embodiments a compliant roller is disclosed which both reduces deformation of the part, and increases dwell times.

For transfusion to occur, the interfaces between the heated layers need to be pressed for at least a minimum duration to allow molecular contact or interdiffusion to occur between the layers. Several factors balance a correlation between the transfer temperature and the minimum transfusion duration, such as (i) thin layer reheating, (ii) layer adhesion to the transfer medium, (iii) print speed and (iv) part heat accumulation. First, the layers being printed are thin. As such, the interfaces between one or more of the previously printed layers are reheated with each successive transfusion step, during which further interdiffusion can occur. As such, the minimum transfusion duration is not limited to a single transfusion step. Rather, the duration may be divided into multiple successive transfusion steps. For example, the 6 seconds required to transfuse the ABS copolymer at a transfer temperature of 160° C. may be divided into 12 successive cycles of about 0.5 second each.

Additionally, while the fusion temperature is high enough to promote rapid layer transfusion, it can also be too hot for the transfused layer to cleanly release or otherwise delaminate from the transfer medium (e.g., a rotatable belt or drum). This can potentially result in portions of the transfused layer remaining adhered to the transfer medium, or smear upon release from the transfer medium (“hot offset”), which negatively impacts feature detail, dimensional accuracy, and porosity of a printed 3D part.

Accordingly, in some embodiments, the layer transfer technique may also include a “transfixing step”, in which the transfer medium and/or the transfused layer is cooled prior to releasing the transfused layer from the transfer medium. While not wishing to be bound by theory, it is believed that this transfixing step cools down the interface between the transfer medium and the transfused layer, thus increasing the adhesive force of the interdiffused polymers in adjacent layers relative to the adhesive force of the transfused layer to the surface of the transfer medium. This keeps the transfused layer adhered to the 3D part in a fixed spatial position, and allows the transfused layer to cleanly release from the transfer medium and remain adhered to the 3D part.

The layer retained by the transfer medium (and optionally, the top surface of the 3D part) may be heated on the transfer medium to a lower transfer temperature (e.g., Temp_{A}), such as a temperature between a glass transition temperature and the fusion temperature of the layer material. In this embodiment, the heated layer is then pressed against a previously-printed layer (or to a build platform) heated to at or above the transfer temperature to conduct heat into the layer being transferred, so that the layer may transfuse to the top-of-part (i.e., a transfusion step), and release from the transfer medium, such as for example 190° C. for ABS material.

As discussed above, a lower transfer temperature decreases the adherence properties of the toner layer, and thus increases the minimum transfusion duration requirement, thus potentially slow down printing speeds. Nonetheless, depending on the particular additive manufacturing system, the transfusion step may not necessarily be the rate limiting step for printing speeds. As discussed below, each layer is imaged (e.g., developed) at an imaging engine, transferred from the imaging engine to a build platform, and thermally treated before and/or after the transfusion step, where any one of these steps may dictate the maximum printing speed attainable.

For example, due to the layers being thin, the imaging of the layers at the imaging engine may be the slowest step in each layer cycle. In this situation, a longer transfusion duration at a lower transfer temperature may be used. The lower transfer temperature allows the heated layer to be hot enough for sufficient polymer interdiffusion over the longer transfusion duration, while also being cool enough to readily release from the transfer medium. As compared to a non-cylindrical roller, a deformable roller increases the forced contact time through increased nip roller transfer area without deforming the top-of-part.

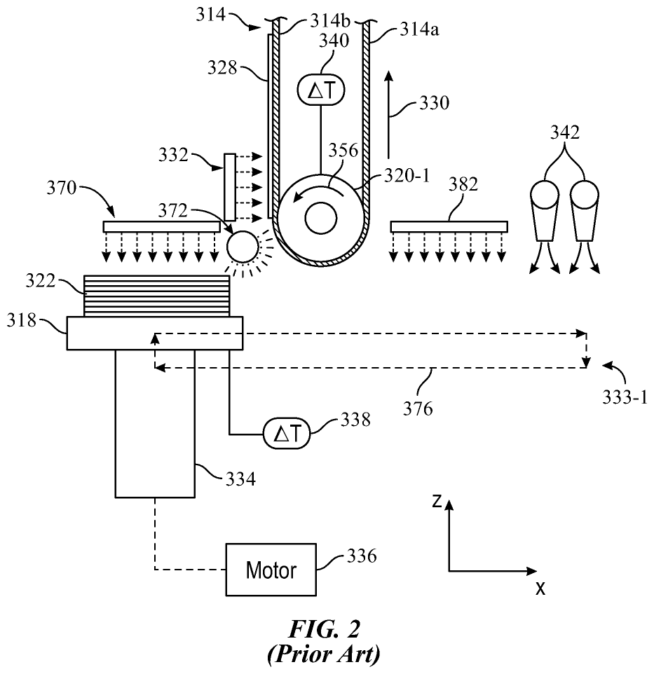

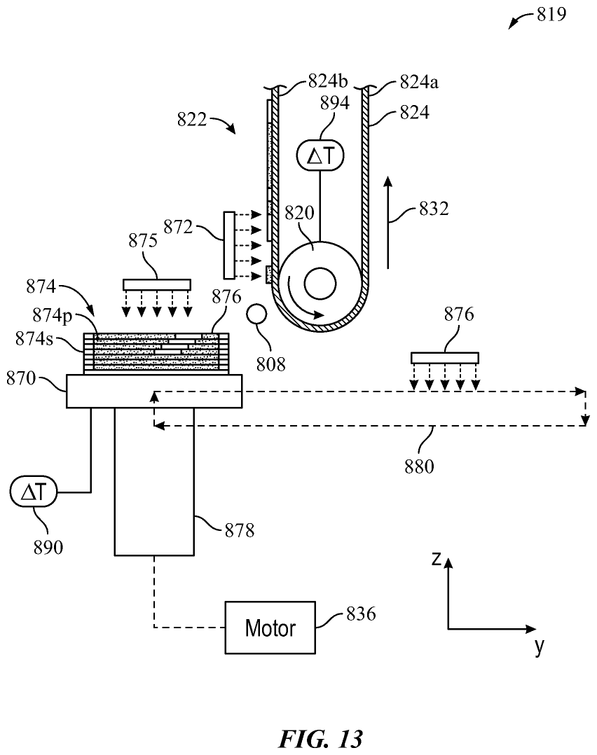

The use of a lower transfer temperature is also particularly suitable for some embodiments of the present disclosure that incorporate post-fuse or heat-setting steps (e.g., layer transfusion assemblies 333 and 433, shown below in FIGS. 2 and 13). In these embodiments, after release, the transfused layer and the 3D part may then be further heated to at least the fusion temperature of the layer material in the post-fuse or heat-setting step. This sufficiently melts the transfused layer material to a fusable state such that polymer molecules of the transfused layer material at least partially interdiffuse to promote interfacial entanglement.

Another factor to consider when balancing the transfer temperature and the minimum transfusion duration involves the bulk temperature of the 3D part being built. Because the imaging system is capable of printing the layers at speeds that are much faster than the rate at which heat diffuses through the variable thermal resistance of the 3D parts, heat accumulation in the 3D parts has been observed. This heat accumulation is proportional to the transfer temperature and the size of the 3D part.

In some embodiments, in order to compensate for lower transfer temperatures of the part layer off the transfusion roller, the top of the part being fabricated can be heated in excess of the melt temperature, for localized melting of just the top surface. That localized heat will be immediately conducted to the newly transfer toner layer, significantly raising its temperature and increasing likelihood of good adhesion between the layer and the part. The deformable roller would further supply contact pressure to promote adhesion, using the larger nip area than would otherwise be achieved with a non-deformable roller, while the heat transfer from the top-of-part raises the transfer temperature so that a shorter transfusion duration is needed.

As such, as the height of a given 3D part grows, heat dissipation from passive thermal diffusion can become insufficient to cool the heated layers. The faster the layer speed, the faster the heat accumulation in the bulk of the 3D part if the cooling is insufficient. As successive layers are continuously printed, this heat accumulation may exceed the “deformation temperature” of the 3D part, causing the bulk of the 3D part to soften enough to reduce its structural integrity. Such a soft part may deform under a subsequently-applied transfusion pressure during a subsequent transfusion step. Disclosed embodiments utilize a compliant transfusion roller having a deformable outer layer to minimize deformation of the part versus a traditional solid transfusion roller.

In some embodiments, even with the use of a compliant transfusion roller, in order to minimize deformation of the part, heat accumulation can be reduced by slowing down the printing process to allow the passive thermal cooling, to lower the part temperature. As mentioned above, the transfer temperature may also be lowered since the printing speed is already being slowed down. However, as can be appreciated, these techniques can substantially increase the time required to print 3D parts, particularly if the layer transfusion step is the rate limiting step in the process, thereby reducing throughput. Instead, to overcome this issue while maintaining fast printing rates, the layer transfer technique may include an “active cooling step” to prevent the 3D part from accumulating additional heat, thereby maintaining the 3D part at an “average part temperature” (Tₚₐᵣₜ) that is lower than the deformation temperature (T_{deform}) of the 3D part.

In particular, after each layer of the 3D part is transfused, the heat added to the 3D part from the transfused layer may be substantially removed prior to the transfusion of the next layer. This holds the 3D part at an average part temperature that is desirably balanced to promote interlayer adhesion and reduce the effects of curling, while also being low enough to prevent the 3D part from softening too much (i.e., below its deformation temperature).

In some embodiments, the compliant roller provides different advantageous effects as the height of the part increases. In general, the part build surface of a part-in-process is not completely flat and planar. As a result, a rigid roller will tend to contact only the taller regions of the part. This is generally a problem if the image on the transfer belt is being pressed onto the part build surface by that rigid roller, since regions of the image not associated with the taller regions are prone to not transfer. This is particularly true when the height of the part is relatively short, such as by way of non-limiting example, less than about 50 mils, a rigid nip roller is incapable of forcing the material downward and into proper adherence between layers. As such the compliant layer of a compliant nip roller deforms at the lower heights to provide the necessary contact to transfuse the layers to the part surface as the part is built.

However, as the part is printed and increases in height, such as by way of non-limiting example, greater than 1 inch, the part can become sufficiently flexible and soft such that the compliant roller is harder than the part. As such, even though the roller has a compliant outer layer, the compliant roller is sufficiently rigid to act as a rigid roller relative to the part being printed.

As such, the compliant roller deforms to the part at the lower heights and is sufficiently rigid to retain its configuration as the part height is increased. Such flexibility in the roller allows for a more accurate part to be printed, particularly for short (non-compliant) parts.

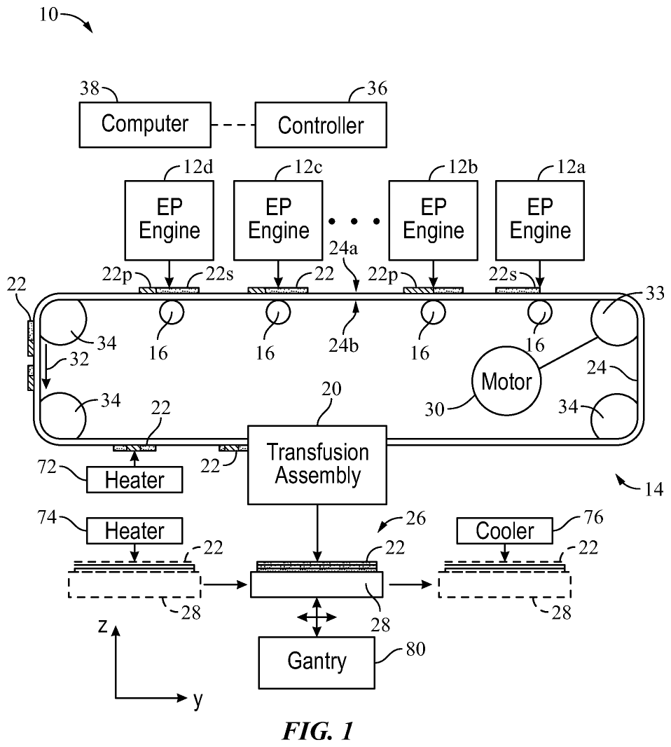

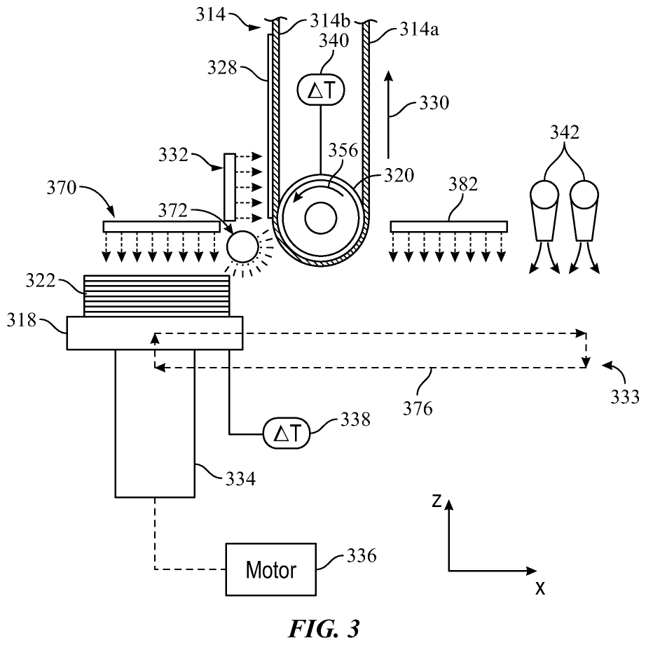

The following embodiments illustrate example additive manufacturing systems of the present disclosure. Referring now to FIG. 1, system 10 is an example additive manufacturing system for printing 3D parts and support structures using electrophotography, which incorporates the layer transfer techniques and layer transfusion assemblies of the present disclosure. The layer transfusion assemblies utilize compliant transfusion rollers to prevent or minimize deformation of the part. One embodiment of a layer transfusion assembly 333 is shown in greater detail in FIG. 3. Examples of other suitable components and functional operations for system 10 include those disclosed in U.S. Pat. Nos. 8,879,957 and 8,488,994, which are herein incorporated by reference in their entirety.

System 10 includes controller 24, which is one or more control circuits, microprocessor-based engine control systems, and/or digitally-controlled raster imaging processor systems, and which is configured to operate the components of system 10 in a synchronized manner based on printing instructions received from host computer 26. Host computer 26 is one or more computer-based systems configured to communicate with controller 24 to provide the print instructions (and other operating information). For example, host computer 26 may transfer information to controller 24 that relates to the sliced layers of a 3D part (and any support structures), thereby allowing system 10 to print the 3D part in a layer-by-layer manner.

While the present disclosure can be utilized with any selective deposition-based additive manufacturing system, such as an electrostatography-based additive manufacturing system, the present disclosure will be described in association in an electrophotography-based (EP) additive manufacturing system. However, the present disclosure is not limited to an EP based additive manufacturing system and can be utilized with any electrostatography-based additive manufacturing system.

FIG. 1 is a simplified diagram of an exemplary electrophotography-based additive manufacturing system 10 for printing 3D parts and associated support structures in a layer-by-layer manner, in accordance with embodiments of the present disclosure. While illustrated as printing 3D parts and associated support structures in a layer-by-layer manner, the system 10 can also be used to form stacks of layers and transfuses the stacks to form the 3D parts and associated support structures.

As shown in FIG. 1, system 10 includes one or more electrophotographic (EP) engines, generally referred to as 12, such as EP engines 12a-d, a transfer assembly 14, at least one biasing mechanism 16, and a transfusion assembly 20. Examples of suitable components and functional operations for system 10 include those disclosed in Hanson et al., U.S. Pat. Nos. 8,879,957 and 8,488,994, and in Comb et al., U.S. Publication Nos. 2013/0186549 and 2013/0186558.

The EP engines 12 are imaging engines for respectively imaging or otherwise developing completed layers of the 3D part, which are generally referred to as 22, of the charged powder part and support materials. The charged powder part and support materials are each preferably engineered for use with the particular architecture of the EP engines 12. In some embodiments, at least one of the EP engines 12 of the system 10, such as EP engines 12a and 12c, develops layers of the support material to form the support structure portions 22s of a layer 22, and at least one of the EP engines 12, such as EP engines 12b and 12d, develops layers of the part material to form the part portions 22p of the layer 22. The EP engines 12 transfer the formed part portions 22p and the support structure portions 22s to a transfer medium 24. In some embodiments, the transfer medium 24 is in the form of a transfer belt, as shown in FIG. 1. The transfer medium 24 may take on other suitable forms in place of, or in addition to, the transfer belt, such as a transfer drum. Accordingly, embodiments of the present disclosure are not limited to the use of transfer mediums 24 in the form of the transfer belt.

In some embodiments, the system 10 includes at least one pair of the EP engines 12, such as EP engines 12a and 12b, which cooperate to form completed layers 22. In some embodiments, additional pairs of the EP engines 12, such as EP engines 12c and 12d, may cooperate to form other layers 22.

In some embodiments, each of the EP engines 12 that is configured to form the support structure portion 22s of a given layer 22 is positioned upstream from a corresponding EP engine 12 that is configured to form the part portion 22p of the layer 22 relative to the feed direction 32 of the transfer belt 24. Thus, for example, EP engines 12a and 12c that are each configured to form the support structure portions 22s are positioned upstream from their corresponding EP engines 12b and 12d that are configured to form the part portions 22p relative to the feed direction 32 of the transfer belt 24, as shown in FIG. 1. In alternative embodiments, this arrangement of the EP engines 12 may be reversed such that the EP engines that form the part portions 22p may be located upstream from the corresponding EP engines 12 that are configured to form the support structure portions 22s relative to the feed direction 32 of the transfer belt 24. Thus, for example, the EP engine 12b may be positioned upstream from the EP engine 12a, and the EP engine 12d may be positioned upstream of the EP engine 12c relative to the feed direction 32 of the transfer belt 24.

As discussed below, the developed layers 22 are transferred to a transfer medium 24 of the transfer assembly 14, which delivers the layers 22 to the transfusion assembly 20. The transfusion assembly 20 operates to build a 3D structure 26, which includes the 3D part 26p, support structures 26s and/or other features, in a layer-by-layer manner by transfusing the layers 22 together on a build platform 28.

In some embodiments, the transfer medium 24 includes a belt, as shown in FIG. 1. Examples of suitable transfer belts for the transfer medium 24 include those disclosed in Comb et al. (U.S. Publication Nos. 2013/0186549 and 2013/0186558). In some embodiments, the belt 24 includes front surface 24a and rear surface 24b, where front surface 24a faces the EP engines 12, and the rear surface 24b is in contact with the biasing mechanisms 16.

In some embodiments, the transfer assembly 14 includes one or more drive mechanisms that include, for example, a motor 30 and a drive roller 33, or other suitable drive mechanism, and operate to drive the transfer medium or belt 24 in a feed direction 32. In some embodiments, the transfer assembly 14 includes idler rollers 34 that provide support for the belt 24. The exemplary transfer assembly 14 illustrated in FIG. 1 is highly simplified and may take on other configurations. Additionally, the transfer assembly 14 may include additional components that are not shown in order to simplify the illustration, such as, for example, components for maintaining a desired tension in the belt 24, a belt cleaner for removing debris from the surface 24a that receives the layers 22, and other components.

System 10 also includes a controller 36, which represents one or more processors that are configured to execute instructions, which may be stored locally in memory of the system 10 or in memory that is remote to the system 10, to control components of the system 10 to perform one or more functions described herein. In some embodiments, the processors of the controller 36 are components of one or more computer-based systems. In some embodiments, the controller 36 includes one or more control circuits, microprocessor-based engine control systems, one or more programmable hardware components, such as a field programmable gate array (FPGA), and/or digitally-controlled raster imaging processor systems that are used to control components of the system 10 to perform one or more functions described herein. In some embodiments, the controller 36 controls components of the system 10 in a synchronized manner based on printing instructions received from a host computer 38 or from another location, for example.

In some embodiments, the controller 36 communicates over suitable wired or wireless communication links with the components of the system 10. In some embodiments, the controller 36 communicates over a suitable wired or wireless communication link with external devices, such as the host computer 38 or other computers and servers, such as over a network connection (e.g., local area network (LAN) connection), for example.

In some embodiments, the host computer 38 includes one or more computer-based systems that are configured to communicate with the controller 36 to provide the print instructions (and other operating information). For example, the host computer 38 may transfer information to the controller 36 that relates to the sliced layers of the 3D parts and support structures, thereby allowing the system 10 to print the layers 22 and form the 3D part including any support structures in a layer-by-layer manner. As discussed in greater detail below, in some embodiments, the controller 36 also uses signals from one or more sensors to assist in properly registering the printing of the part portion 22p and/or the support structure portion 22s with a previously printed corresponding support structure portion 22s or part portion 22p on the belt 24 to form the individual layers 22.

The components of system 10 may be retained by one or more frame structures. Additionally, the components of system 10 may be retained within an enclosable housing that prevents components of the system 10 from being exposed to ambient light during operation.

Referring now to FIG. 2, shown is a prior art transfusion assembly 333-1 similar to transfusion assembly 333 shown in FIG. 3, but utilizing a conventional rigid nip roller 320-1 instead of a compliant nip roller 320. Transfusion assemblies 333-1 and 333 include post-fuse heaters 382 configured to perform a post-fuse or heat-setting step by heating the part surface to an elevated temperature (e.g., to at least the fusion temperature of the thermoplastic-based powder) after transferring a layer.

As shown in FIGS. 2 and 3, this post-fuse step follows the transfusion/transfixing and release steps of the layer transfer process, which may be performed at a transfer temperature that is below the fusion temperature of the thermoplastic-based powder. The addition of post heaters 382 in layer transfusion assemblies 333-1 and 333 permits transferring of layers to 3D part 322 at transfer temperatures optimized for clean and quick transfer of layers, without sacrificing part strength gained through interfacial bonding of the layer material at the fusion temperature of the thermoplastic-based powder. In this manner, part quality may be optimized for dimensional accuracy and porosity (by a clean transfer), and also for strength.

As shown, layer transfusion assemblies 333-1 and 333 also include heaters 370 and 372 (in addition to post-fuse heater 382). Heaters 370 and 372 heat the top surface or layer(s) of 3D part 322 prior to the transfusion step. Post heater 382 is located downstream from nip rollers 320-1 and 320, and upstream from air jets 342, and is configured to heat the transfused layers to an elevated temperature in the post-fuse or heat-setting step.

Prior to printing 3D part 322, build platform 318 and nip rollers 320-1 and 320 may be heated to their desired temperatures using heaters 338 and 340, respectively. For example, build platform 318 may be heated to the average part temperature (e.g., about 130° C. for an ABS copolymer). However, nip rollers 320-1 and 320 may be heated to a desired transfer temperature for an imaged layer 328.

Alternatively, the build platform 318 may begin with heating to an average part temperature, and later be reduced in temperature to help control overall part temperature as the build progresses.

During the printing operation, belt 314 carries the imaged powder layer 328 past heater 332, which heats the imaged powder layer 328 to the transfer temperature. The transfer temperature for imaged powder layer 328 is desirably less than its fusion temperature, but high enough to achieve partial entanglement of the polymer molecules between the heated layer 328 and 3D part 322 during the subsequent transfusion step. Suitable transfer temperatures for the thermoplastic-based powder include temperatures that exceed the glass transition temperature of the thermoplastic-based powder, where the layer material is softened but not melted, for example, a temperature of ranging from about 140° C. to about 180° C. for an ABS copolymer.

As further shown in FIGS. 2 and 3, during operation, gantry 334 may move build platform 318 and 3D part 322 in a reciprocating pattern, such as but not limited to a rectangular pattern, (depicted by arrows 376). In particular, gantry 334 moves build platform 318 along the x-axis below, along, or through heater 370. Heater 370 heats the top surface of 3D part 322 to an elevated temperature, such as the transfer temperature of the thermoplastic-based powder. Heaters 332 and 370 may heat the imaged powder layers 328 and the top surface of 3D part 322 to about the same temperatures to provide a consistent transfusion interface temperature. Alternatively, heaters 332 and 370 may heat the imaged powder layers 328 and the top surface of 3D part 322 to different temperatures to attain a desired transfusion interface temperature. The top-of-part may be heated much higher than the fusion temperature of the material in a localized fashion, in order to thermally conduct heat energy to the lower temperature transfusion layer and increase the likelihood of successful fusion.

The continued rotation of belt 314 and the movement of build platform 318 align the heated layer 328 with the heated top surface of 3D part 322 with proper registration along the x-axis. Furthermore, the heated layer 328 and the heated top surface of 3D part 322 may each pass heater 372, which may be configured to heat and/or maintain both the heated layer 328 and the heated top surface of 3D part 322 at the transfer temperature. This prevents the heated layer 328 from cooling down prior to reaching nip rollers 320-1 and 320, respectively, and brings the temperature of the heated top surface of 3D part 322 to or near the transfer temperature before the next transfusion step is performed. In alternative embodiments, heater 372 may be omitted.

Gantry 334 may continue to move build platform 318 (and 3D part 322) along the x-axis, at a rate that is synchronized with the rotational rate of belt 314 in the direction of arrow 330 (i.e., the same directions and speed). This causes rear surface 314b of belt 314 to rotate around nip roller to nip belt 314 and the heated layer 328 against the top surface of 3D part 322. This engages build platform 318 and belt 314, and presses the heated layer 328 between the heated top surface of 3D part 322 and belt 314 at the location of the nip roller. This at least partially transfuses heated layer 328 to the top layer of 3D part 322.

As the transfused layer 328 passes the nip of nip roller 320-1 or 320, belt 314 wraps around the nip roller to separate and disengage from build platform 318. This assists in releasing the transfused layer 328 from belt 314, in an assisted delamination step, allowing the transfused layer 328 to remain adhered to 3D part 322. As discussed above, maintaining the transfusion interface temperature at a transfer temperature that is higher than its glass transition temperature, but lower than its fusion temperature, allows the heated layer 328 to be hot enough to adhere to 3D part 322, while also being cool enough to readily release from belt 314.

After release, gantry 334 continues to move build platform 318 (and 3D part 322) along the x-axis to an optional post-fuse heater 382. At post-fuse heater 382, the transfused layer 328 and 3D part 322 are then heated to at least the fusion temperature of the thermoplastic-based powder in a post-fuse or heat-setting step. This melts the material of the transfused layer 328 to a highly fusable state such that polymer molecules of the transfused layer 328 quickly interdiffuse to achieve a high level of interfacial entanglement with 3D part 322.

Additionally, as gantry 334 continues to move build platform 318 (and 3D part 322) along the x-axis past post-fuse heater 382 to air jets 342, air jets 342 blow cooling air towards the top layers of 3D part 322. This actively cools the transfused layer 328 down to the average part temperature, as discussed above.

Gantry 334 may then actuate build platform 318 (and 3D part 322) downward, and move build platform 318 (and 3D part 322) back along the x-axis to a starting position along the x-axis, following the reciprocating rectangular pattern 376. Build platform 318 desirably reaches the starting position for proper registration with the next layer 328. In some embodiments, gantry 334 may also actuate build platform 318 and 3D part 322 upward for proper registration with the next layer 328. The same process may then be repeated for each remaining layer 328 of 3D part 322.

Layer transfusion assemblies 333-1 and 333 provide mechanisms for transfusing the imaged layers 428 together at 3D part 322, while also keeping the heated layers 328 cool enough for clean release from belt 314. The heat-setting step performed after releasing each transfused layer 328 from belt 314 accordingly increase interlayer adhesion to promote good part strengths.

Additionally, air jets 342 (or other cooling units) substantially remove the heat that is added from heating elements 332, 370, and 372, and post-fuse heater 382 prior to printing the next layer 328. This active cooling substantially removes the heat provided by each layer 328, thereby providing substantially zero heat accumulation after each printed layer 328. As such, 3D part 322 may be substantially maintained at an average part temperature that is below its deformation temperature during the entire printing operation. Further, the top layer surface temperature of the printed 3D part 322 may be brought back up to above its glass transition temperature using heaters 370 and/or 372 for transfusion of the next layer 328.

In previous layer transfusion assemblies such as assembly 333-1 shown in FIG. 2, nip roller 320-1 can be made to have an outer contact surface made of rubber or other similar materials. At higher bulk temperatures, for example above 155° C. using ABS toner, the outer contact surface material of roller 320-1 may be somewhat deformable under pressure so as to reduce deformation of the part. However, contact with roller 320-1 may still cause excessive part deformation. Further, at lower bulk temperatures, for example below 130° C., which may be desirable in some systems, the material of roller 320-1 can harden, causing even more deformation of the part when in contact with the roller. In some exemplary embodiments, careful selection of roller material can be made to optimize the amount of deformation of the roller at a particular operating temperature setpoint, versus deformation of the part material.

In order to reduce or prevent deformation of the part, particularly at lower temperatures, nip roller 320 includes outer contact surface material which is more deformable at lower temperatures as compared to the contact surface material of nip roller 320-1. For example, in exemplary embodiments, it has been found that an outer contact surface material of nip roller 320 having a durometer of less than 60 Shore A resulted in little part deformation. As a material having too low of a durometer can prevent nip roller 320 from performing as necessary, it has been found that in some embodiments the outer contact material was should have a durometer within a range between 10 Shore A and 60 Shore A. As the boundary durometer values of this range may result in a nip roller which is too soft or too hard, it has been found that in exemplary embodiments the outer contact material can have a durometer within a narrower range between approximately 20 Shore A and 50 Shore A. In various embodiments, the elastic modulus of the compliant roller material is chosen for particular operating temperatures and conditions (e.g., materials used, pressures, dwell times, etc.) such that the roller deforms rather than the part. The deformable roller may either have a solid core and deformable outer layer, or may consist completely of a deformable material if desired.

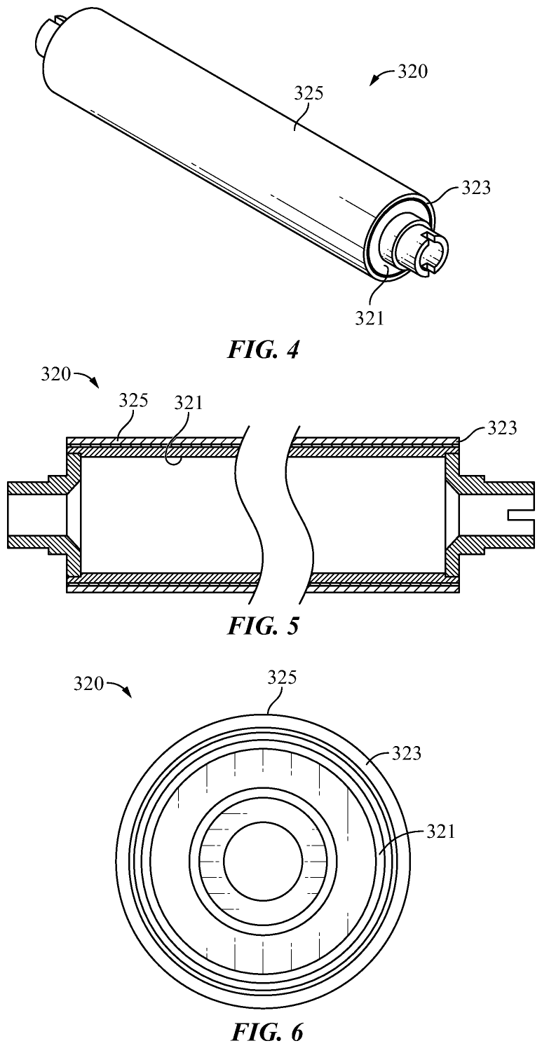

Referring now to FIGS. 4-6, shown is an example embodiment of nip roller 320 in accordance with some embodiments. FIGS. 4 and 6 are perspective and end views, respectively, of nip roller 320. FIG. 5 is a cross sectional side view of the nip roller. As can be seen in FIGS. 4-6, nip roller 320 includes an outer layer 323 of material surrounding an inner roller material 321. In an example embodiment, the inner roller material 321 can be stainless steel or other rigid materials. Outer layer 323 of material, providing the outer contact surface 325, is a deformable material having a durometer of less than 60 Shore A, for example between 20 Shore A and 50 Shore A. In an exemplary embodiment, outer layer 323 is a silicon rubber material. The thickness of outer layer 323 can vary as needed to allow for sufficient deformation for particular systems. In one exemplary embodiment, outer layer 323 has a thickness of approximately 0.36 inch and is positioned on an inner roller having an outer diameter of 3.70 inches, but this need not be the case in all embodiments. Any suitably dimensioned rollers and layers can be used. For example, in embodiments utilizing a separate outer layer 323, a thickness of the outer layer material of between 0.1 inch and 0.5 inch has been found to perform well. Further, in some embodiments, the nip roller is formed entirely of a deformable material, and a separate outer layer is not required.

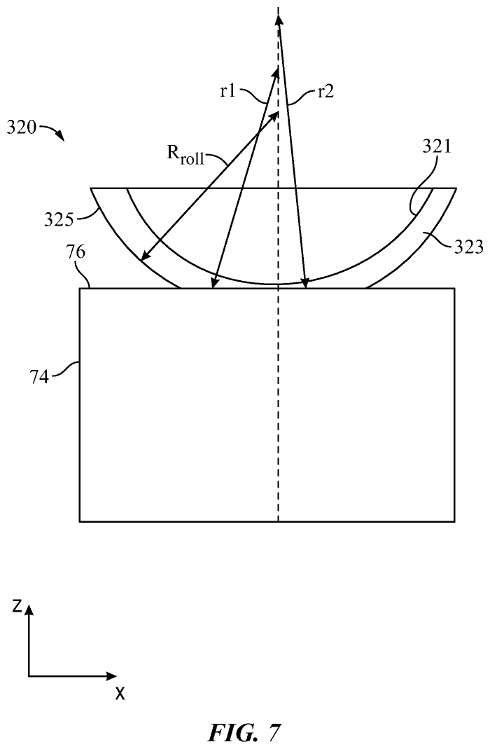

Referring now to FIG. 7, shown diagrammatically is a portion of nip roller 320 illustrating deformation of outer layer 323 when outer contact surface 325 is applied with pressure to a top or build surface 76 of a part 74. As part 74 is engaged by roller 320, outer layer 323 deforms, lengthening the outer roller radius of curvature from an original radius Rᵣₒₗₗ to a radius of curvature which corresponds to a localized flattening of the engaged portion of outer layer 323. The radius of curvature of outer layer 323 continues to lengthen from original radius Rᵣₒₗₗ to a midpoint of contact between roller 320 and part 74, and then begins to shorten. FIG. 7 illustrates two lengthened radii of curvature, r₁ and r₂, with the longer radius of curvature r₂ being closest to the midpoint of contact with the part. Using a compliant roller material which has a high degree of deformability results in minimal deformation of the part. Conventionally, most of the deformation between the roller and the part occurred in the layers of the part. Using the presently disclosed concepts and compliant roller features, most of the deformation between the roller and the part occurs in the roller so that the part does not substantially deform.

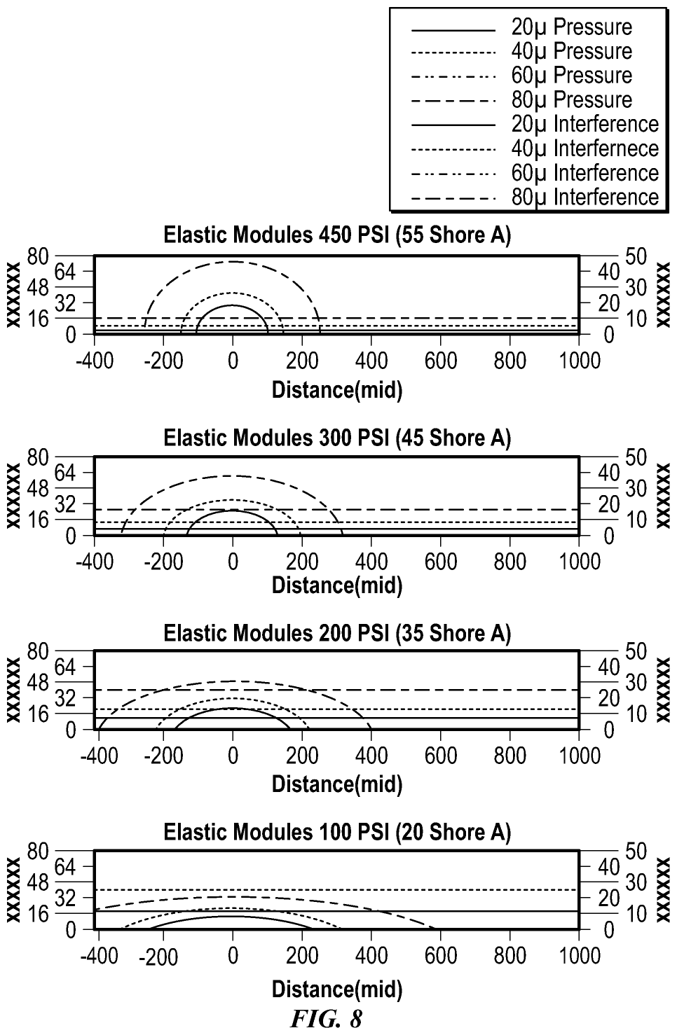

As noted above, the degree of deformation of roller 320, for example outer layer 323, is dependent upon several factors including the hardness of the roller material used and the pressure applied by the roller to the part. It must be noted that deformation of roller 320 can be primarily deformation of an outer layer 323 of deformable material, but need not be in all embodiments. For example, in some embodiments the entire roller can be made from a deformable material. Discussions of deformation of roller 320 or outer layer 323 are intended to include both types of embodiments. FIG. 8 plots deformation of roller 320 for materials having elastic moduli of 450 psi (55 shore A), 300 psi (45 shore A), 200 psi (35 shore A) and 100 psi (20 shore A), respectively, at contact pressures of 20 psi, 40 psi, 60 psi and 80 psi. Increased deformation of the roller 320 can be seen as the material hardness decreases. In exemplary embodiments, the outer layer material is selected to have an elastic modulus of between 70 psi and 240 psi, as excessive deformation of the outer layer can prohibit the roller from functioning as a transfusion roller.

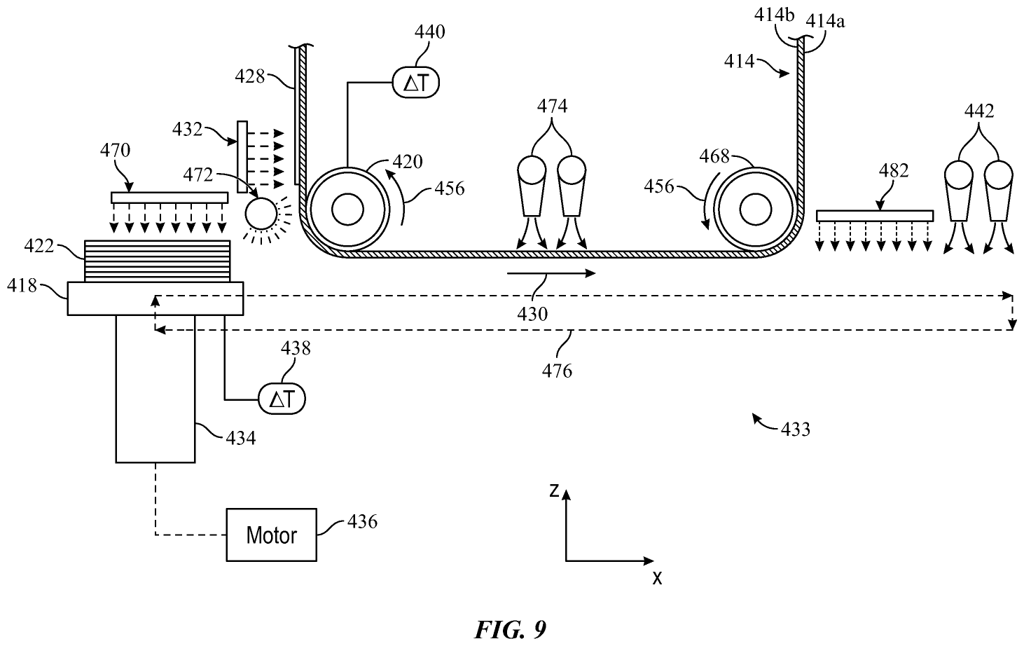

In exemplary embodiments, the disclosed compliant roller(s) can be used in different systems and in different layer transfusion assembly configurations. For example, as shown in FIG. 9, layer transfusion assembly 433 includes post-fuse heater 482 located downstream from release roller 468 and upstream from air jets 442, which may operate in the same manner as post-fuse heater 382 to heat the transfused layers to at least the fusion temperature of the thermoplastic-based powder in the post-fuse or heat-setting step.

Prior to printing 3D part 422, build platform 418 and compliant nip fusion roller 420, which can be similar to roller 320 discussed above, may be heated to their desired temperatures by heaters 438 and 440, respectively. For example, build platform 418 may be heated to the average part temperature and fusion roller 420 may be heated to an elevated temperature, such as to the fusion temperature of the thermoplastic-based powder, or to a lower transfer temperature. During the printing operation, belt 414 carries an imaged powder layer 428 past heater 432, which heats the imaged powder layer 428 and the associated region of belt 414 to an elevated transfer temperature, desirably above the glass transition temperature and typically not exceeding the fusion temperature of the thermoplastic-based powder.

During operation, under power from motor 436, gantry 434 may move build platform 418 and 3D part 422 in a reciprocating rectangular pattern (depicted by arrows 476) in the same manner as gantry 334. Gantry 434 may move build platform 418 along the x-axis below, along, or through heater 470, which heats the top surface of 3D part 422 to an elevated transfer temperature, likewise above the glass transition temperature and desirably not to exceeding the fusion temperature of the thermoplastic-based powder.

The continued rotation of belt 414 and the movement of build platform 418 align the heated layer 428 with the heated top surface of 3D part 422 with proper registration along the x-axis. Furthermore, the heated layer 428 and the heated top surface of 3D part 422 may each pass heater 472, which may be configured to heat and/or maintain both the heated layer 428 and the heated top surface of 3D part 422 at the transfer temperature. This prevents the heated layer 428 from cooling down prior to reaching fusion roller 420, and brings the temperature of the heated top surface of 3D part 422 to the transfer temperature before the next transfusion step is performed.

Gantry 434 may continue to move build platform 418 (and 3D part 422) along the x-axis, at a rate that is synchronized with the rotational rate of belt 414 in the direction of arrow 430 (i.e., the same directions and speed). This causes rear surface 414b of belt 414 to rotate around fusion roller 420 to nip belt 414 and the heated layer 428 against the heated top surface of 3D part 422. This engages build platform 418 and belt 414, and presses the heated layer 428 between the heated top surface of 3D part 422 and belt 414 at the location of fusion roller 420 to perform the transfusion step.

By separating fusion roller 420 and release roller 468, with a cooling step therebetween via air jets 474 (or other cooling mechanism), layer transfusion assembly 433 also allows the layers to be heated to a transfusion interface temperature higher than is permitted in using layer transfusion assembly 333. Where layer 428 and the heated top layer of 3D part 422 are heated to, at, or near the fusion temperature of the thermoplastic-based powder, the pressed heated layer 428 transfuses to the heated top surface of 3D part 422 with a high level of interlayer adhesion. In exemplary embodiments, release roller 468 can also be a compliant fusion roller similar to roller 320 discussed above, but this need not be the case.

After passing fusion roller 420, and while build platform 418 remains engaged with belt 414, belt 414, build platform 418, and 3D part 422 pass air jets 474, which cool belt 414 the side of rear surface 414b. In alternative embodiments, air jets 474 may be a variety of different convective and/or conductive cooling units, such as refrigeration units, liquid-cooling units, evaporation units, and the like. Cooling belt 414 with air jets 474 allows the interface between front surface 414a of belt 414 and the transfused layer 428 to cool so that the transfused layer 428 will remain adhered to 3D part 422 and cleanly release from belt 414.

In particular, as the transfused layer 428 passes the nip of release roller 468, belt 414 rotates around release roller 468 to separate and disengage from build platform 418. This assists in releasing the transfused layer 428 from belt 414, in an assisted delamination step, allowing the transfused layer 428 to remain adhered to 3D part 422.

After release, gantry 434 continues to move build platform 418 (and 3D part 422) along the x-axis to post-fuse heater 482. At post-fuse heater 482, the transfused layer 428 and 3D part 422 are then heated back up to the fusion temperature of the thermoplastic-based powder in a heat-setting step. This melts the material of the transfused layer 428 to a fusable state such that polymer molecules of the transfused layer 428 become highly interdiffused to promote interfacial entanglement with 3D part 422. In effect, layer transfusion assembly 433 generates two interdiffusion steps separated by a transfixing step, a process particularly suitable for building very high strength parts.

Additionally, as gantry 434 continues to move build platform 418 (and 3D part 422) along the x-axis past post-fuse heater 482 to air jets 442, air jets 442 blow cooling air towards the top layers of 3D part 422. This actively cools the transfused layer 428 down to the average part temperature, as discussed above.

Gantry 434 may then actuate build platform 418 (and 3D part 422) downward, and move build platform 418 (and 3D part 422) back along the x-axis to a starting position along the x-axis, following the reciprocating rectangular pattern 476. Build platform 418 desirably reaches the starting position for proper registration with the next layer 428. In some embodiments, gantry 434 may also actuate build platform 418 and 3D part 422 upward for proper registration with the next layer 428. The same process may then be repeated for each remaining layer 428 of 3D part 422.

Layer transfusion assembly 433 provides a further alternative mechanism for transfusing the layers together, while also keeping the heated layers 428 cool enough for clean release from belt 414. The separation of fusion roller 420 and release roller 468, with a cooling or transfixing step therebetween via air jets 474, allows the layers to be heated to an optimal transfusion interface temperature, and to be cooled to a temperature that transfixes the layers 428 before release. Furthermore, the heat-setting step via post-fuse heater 482 provides an even greater control over part strength.

Accordingly, the thermal profile of the layers 428 and 3D part 422 may be tightly controlled to meet a variety of requirements. After release from belt 414, the transfused layer 428 may then be reheated to at least its fusion temperature via post-fuse heater 482, as discussed above, to further promote interfacial entanglement with 3D part 422.

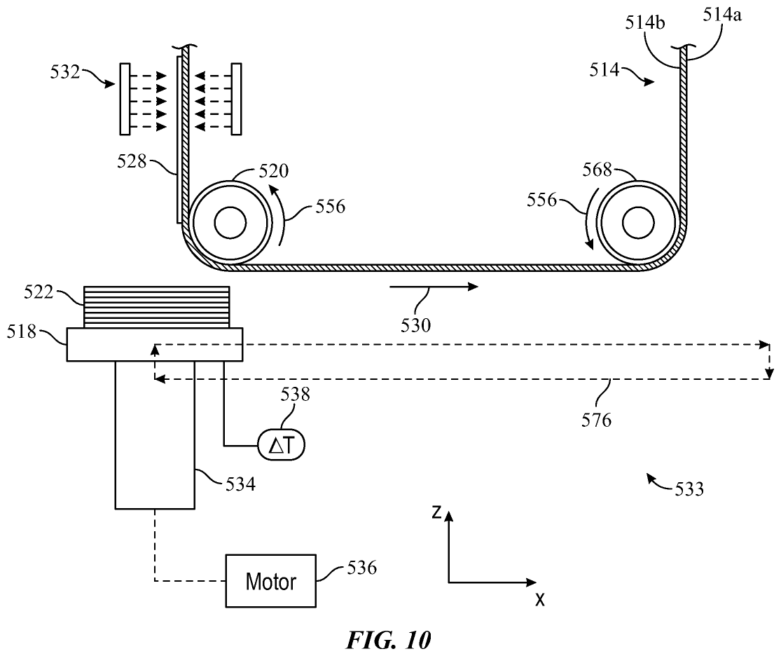

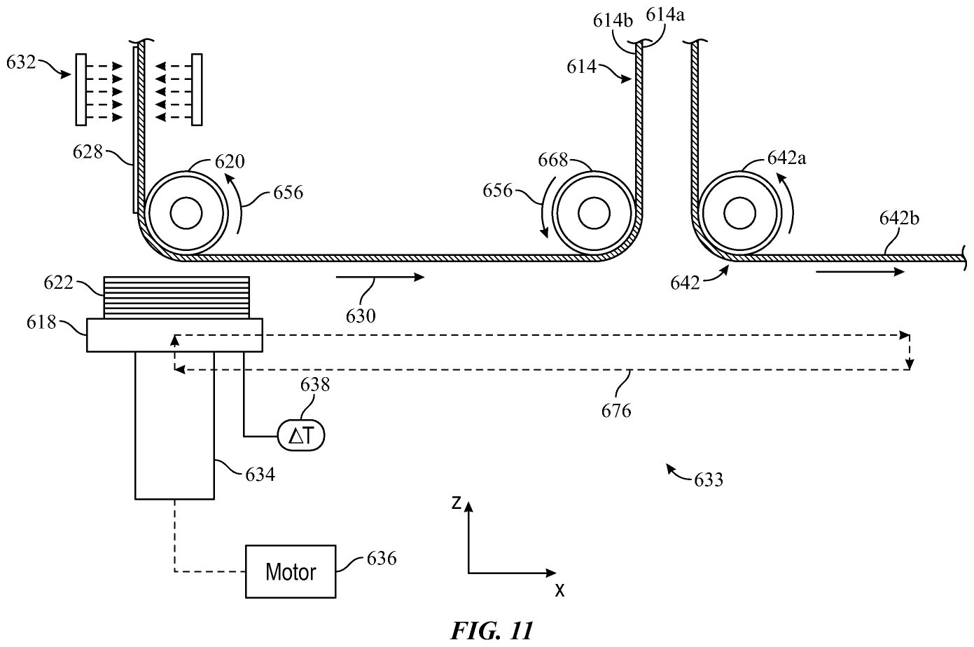

FIGS. 10 and 11 illustrate layer transfusion assemblies 533 and 633, which are further alternatives layer transfusion assembly 333, where air jets 274 are omitted. For example, as shown in FIG. 9, layer transfusion assembly 533 may function in a similar manner to layer transfusion assembly 333, where the reference numbers of the respective components are increased by “200” from layer transfusion assembly 333.

In this embodiment, belt 514 desirably functions as a heat capacitor for heating the layers 528 and 3D part 522. In particular, belt 514 desirably has a high thermal conductivity and high heat capacity, as discussed below. Heater 532 as shown is a non-contact radiant heater that directs heat to opposing faces of the belt, so as to heat the belt itself along with heating an imaged powder layer 528. As such, after being heated with heater 532, belt 514 may be the sole source of heating for the transfusion step, and nip roller 520 may optionally be unheated or heated to a lower temperature (e.g., the desired average part temperature). In other embodiments, an alternative or additional heat source may be used in place of heater 532, such as contact heat source or non-radiant heaters. Nip roller 520 can be the same or similar to compliant roller 320 discussed above

Accordingly, prior to printing 3D part 522, build platform 518 may be heated to its desired temperature (e.g., the average part temperature) by heater 538. During the printing operation, belt 514 carries imaged powder layer 528 past heater 532, which heats the imaged powder layer 528 and the associated region of belt 514 to an elevated transfer temperature, such as the fusion temperature of the thermoplastic-based powder. In this embodiment, due to its higher thermal conductivity and heat capacity, belt 514 desirably continues to heat the heated layer 528 during transit to build platform 518.

During operation, gantry 534 may move build platform 518 and 3D part 522 in a reciprocating rectangular pattern (depicted by arrows 576) in the same manner as gantries 134, 234, 334, and 434. The continued rotation of belt 514 and the movement of build platform 518 align the heated layer 528 with the top surface of 3D part 522 with proper registration along the x-axis. Gantry 534 may continue to move build platform 518 (and 3D part 522) along the x-axis, at a rate that is synchronized with the rotational rate of belt 514 in the direction of arrow 530 (i.e., the same directions and speed). This causes rear surface 514b of belt 514 to rotate around nip roller 520 to nip belt 514 and the heated layer 528 against the heated top surface of 3D part 522. This engages build platform 518 and belt 514, and presses the heated layer 528 between the top surface of 3D part 522 and belt 514 at the location of nip roller 520 to perform the transfusion step.

The conductive heating from belt 514 directly heats only those areas of 3D part 522 that are being fused together (i.e., the areas of 3D part 522 that are in contact with the heated layer 528 or belt 514. Additionally, belt 514 desirably conducts thermal energy to the transfused layer 528 and 3D part 522 as belt 514 and build platform 518 continue to move in the direction of arrow 530 from nip roller 520 to release roller 568. While not wishing to be bound by theory, it is believed that the release of thermal energy from belt 514 to the transfused layers of 3D part 522 during this step provides two functions.

First, it continues to heat the transfused layers of 3D part 522, thereby increasing the interlayer adhesion. For example, if belt 514 and layer 528 are heated to a fusion temperature of about 200° C., and 3D part 522 is maintained at an average part temperature of about 100° C., the initial transfusion interface temperature for transfusing the layers together starts at about 150° C. However, the continued conductance of thermal energy from belt 514 to the transfused layers of 3D part 522 while moving from nip roller 520 to release roller 568 increases the transfusion interface temperature. This accordingly increases the extent that the polymer molecules adhere, promoting interfacial entanglement, pursuant to the plot line function of ƒ(τᵣ) in FIG. 1 and Equations 1-3.

Second, the conductive heat transfer, which draws heat from belt 514 and layer 528 into the top-most layers of 3D part 522, cools belt 514 and layer 528 down from the fusion temperature to a lower temperature, so that when passing release roller 568 the transfused layer 528 may remain adhered to 3D part 522 and cleanly release from belt 514. Thus, drawing heat from belt 514 in this manner cools belt 514 and layer 528 down in a similar manner to air jets 274 and 474, without employing the jets.

In particular, as the transfused layer 528 passes the nip of release roller 568, belt 514 rotates around release roller 568 to separate and disengage from build platform 518. This assists in releasing the transfused layer 528 from belt 514, in an assisted delamination step, allowing the transfused layer 528 to remain adhered to 3D part 522.

After release, belt 514 may rotate back around to EP engine 12 (shown in FIG. 1), and may be cooled down further with additional cooling mechanisms (not shown) or via ambient cooling. Gantry 534 may actuate build platform 518 (and 3D part 522) downward, and move build platform 518 (and 3D part 522) back along the x-axis to a starting position along the x-axis, following the reciprocating rectangular pattern 576. Build platform 518 desirably reaches the starting position for proper registration with the next layer 528. In some embodiments, gantry 534 may also actuate build platform 518 and 3D part 522 upward for proper registration with the next layer 528. The same process may then be repeated for each remaining layer 528 of 3D part 522.

Layer transfusion assembly 533 provides a further alternative mechanism for transfusing the layers together, while also keeping the heated layers 528 cool enough for clean release from belt 514. The separation of fusion roller 520 and release roller 568, with a cooling or transfixing step therebetween via the thermal conductance from belt 514 to 3D part 522, allows the layers to be heated to an optimal transfusion interface temperature, and to be cooled to a temperature that transfixes the layers 528 before release. In some embodiments, release roller 568 can also be a compliant roller similar to roller 320 discussed above, but this need not be the case in all embodiments.

In some embodiments, layer transfusion assembly 533 may also optionally include one or more pre-heaters to direct heat towards the top surface of 3D part 522 prior to the transfusion step; one or more air jets (e.g., air jets 474) to assist in further cooling belt 514; one or more post-fuse heaters (e.g., post-fuse heaters 382 and 482) to reheat 3D part 522; and/or one or more active cooling air units (e.g., air jets 342, and 442) to assist in maintaining 3D part 522 at its desired average part temperature.

However, the high thermal conductivity and heat capacity of belt 514 allows layer transfusion assembly to selectively transfer heat only to those areas of 3D part 522 that are being fused together. This conductive heating reduces the risk of melting melt small part features of 3D part 522 that have been completed and are not being fused with the current layer 528. This is in addition to allowing a reduced number of heating and cooling units in layer transfusion assembly 533, thereby reducing the number of re-heating and re-cooling steps.

Examples of suitable average thermal conductivities for belt 514 include thermal conductivities of at least about 0.12 watts/meter-Kelvin (W/m-K), with particularly suitable average thermal conductivities ranging from about 0.2 W/m-K to about 0.5 W/m-K, where the average thermal conductivities are measured pursuant to ASTM E1225-09. Furthermore, examples of suitable average heat capacities for belt 514 include specific heat capacities of at least about 1,000 joules/(kilogram-Kelvin) (J/kg-K), with particularly suitable average heat capacities ranging from about 2,000 J/kg-K to about 3,000 J/kg-K, where the specific heat capacities are measured pursuant to ASTM E1269-11.

Examples of suitable materials for belt 514 include polymeric and metallic materials, which may be doped with one or more conductive materials to promote the electrostatic charges. Examples of suitable polymeric materials include polyimide materials, such as those commercially available under the trade designation “KAPTON” from E.I. du Pont de Nemours and Company, Wilmington, Del.

FIG. 11 illustrates layer transfusion assembly 633, which is an alternative to layer transfusion assembly 533 (shown in FIG. 10), where the reference numbers of the respective components are increased by “100” from layer transfusion assembly 533. As shown in FIG. 11, layer transfusion assembly 633 also includes cooling unit 642, which is a conductive cooling unit to actively cool 3D part 622 in a similar manner to air jets 342, and 442 to assist in maintaining 3D part 622 at its desired average part temperature.

However, in comparison to non-contact cooling units (e.g., air jets 342, and 442), cooling unit 642 selectively cools only the areas of 3D part 622 that are in contact with cooling unit 642. In particular, cooling unit 642 may include roller 642a and cooling belt 642b, where cooling belt 642b is configured to rotate around roller 642a (and other idler and/or drive rollers), desirably at a rate that is synchronized with the movement of build platform 618 and 3D part 622 along the x-axis in the direction of arrow 630. Belt 642b itself desirably has a thermal conductivity and is cooled down (e.g., via a refrigeration unit or other cooling mechanism, not shown) to function as a heat sink. In alternative embodiments, cooling unit 642 may include any suitable mechanism for drawing thermal energy from 3D part 622 via thermal conduction (e.g., a rotatable cold drum or a reciprocating cold platform).

In this embodiment, after moving past release roller 668, the top surface of 3D part 622 desirably contacts and moves along with belt 642b for a sufficient duration to actively draw heat from 3D part 622 in an active cooling step. As mentioned above, this selectively cools only the areas of 3D part 622 that are in contact with cooling unit 642, rather than a global cooling of 3D part 622. As can be appreciated, during each transfusion step with belt 614, which selectively heats only those areas of 3D part 622 that are being fused together, the majority of the heat drawn into 3D part 622 resides at the top-most layers of 3D part 622. As such, selectively drawing heat from these same areas promptly after the transfusion steps prevents the heat from diffusing into the bulk of the part, without globally cooling 3D part 622.

Accordingly, the combination of belt 614 and cooling unit 642 allows layer transfusion assembly 633 to directly heat and cool only those areas of 3D part 622 that are being fused. This may eliminate bulk heating and bulk cooling steps that potentially impart undesirable effects such as melting of small features that have been completed, or over cooling of surfaces that are still under construction. As discussed above with reference to complaint roller 320, nip roller 620 is of a similar construction to deform when in contact under pressure with the part. Rollers 668 and 642a can similarly be compliant rollers, but need not be in all embodiments.

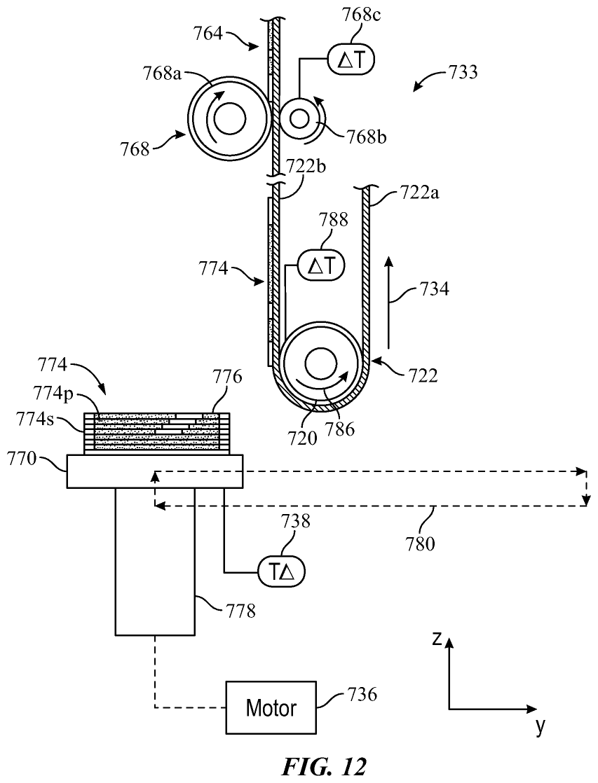

FIG. 12 illustrates another example embodiment of a layer transfusion assembly 733. As shown, layer transfusion assembly 733 includes pre-sintering heater 768, build platform 770, and nip roller 720. In alternative embodiments, layer transfusion assembly 733 may also optionally include one or more post-fuse heaters and air jets (or other cooling units), and/or other arrangements (e.g., press plates, multiple rollers, etc. . . . ) as described in Comb et al., U.S. Publication Nos. 2013/0186549 and 2013/0186558, which are herein incorporated by reference.

Pre-sintering heater 768 (also depicted above in FIG. 1) is one or more heating devices (e.g., an infrared heater, a heated air jet, and/or a contact roller) configured to sinter the powder-based materials of layers 764 prior to reaching nip roller 720. Each layer 764 desirably passes by (or through) pre-sintering heater 768 for a sufficient residence time to heat the layer 764, thereby sintering the powder-based material into a sintered contiguous film 764f. Pre-sintering heater 768 is preferably located upstream from nip roller 720 by a sufficient distance to allows the sintered film 764f to partially cool down prior to a desired transfer temperature before reaching nip roller 720. Nip roller 720 can be of a compliant roller construction such as discussed above with reference to roller 320.

Build platform 770 is a platform assembly or platen that is configured to receive the sintered film 764f for printing a 3D part and any associated support structure, referred to as 3D part 774p and support structure 774s, in a layer-by-layer manner. For ease of discussion, 3D part 774p and support structure 774s are herein referred to collectively as 3D part 774 having an intermediate build surface 776. In some embodiments, build platform 770 may include removable film substrates (not shown) for receiving the sintered layers 764f, where the removable film substrates may be restrained against build platform 770 using any suitable technique (e.g., vacuum drawing, removable adhesive, mechanical fastener, magnetic attraction, and the like).

Build platform 770 is supported by gantry 778, which is a gantry mechanism configured to move build platform 770 along the z-axis and the y-axis, preferably to produce a reciprocating rectangular pattern, where the primary motion is back-and-forth along the y-axis (illustrated by broken lines 780). While the reciprocating rectangular pattern is described as a rectangular pattern with sharp axial corners (defined by arrows 780), gantry 778 may move build platform 770 in a reciprocating rectangular pattern having rounded or oval-defining corners, so long as build platform 770 moves along the y-axis during the pressing steps. Gantry 778 may be operated by motor 736 based on commands from controller 24, where motor 736 may be an electrical motor, a hydraulic system, a pneumatic system, or the like.

In the shown embodiment, build platform 770 is heatable with heating element 738 (e.g., an electric heater). Heating element 738 is configured to heat and maintain build platform 770 at an elevated temperature that is greater than room temperature (25° C.), and more preferably at about the glass transition temperature of the part material, or closely below the glass transition temperature, such as within about 15° C., about 10° C., or even about 5° C. below the glass transition temperature.

Nip roller 720 is an example of a heatable pressing element, which is configured to rotate around a fixed axis with the movement of belt 722. In particular, nip roller 720 may roll against rear surface 722b in the direction of arrow 786 while belt 722 rotates in the direction of arrow 734. In the shown embodiment, nip roller 772 is heatable with heating element 788 (e.g., an electric heater). Heating element 788 is configured to heat and maintain nip roller 720 at an elevated temperature that is greater than room temperature (25° C.), such as at substantially the same temperature as build platform 770 (e.g., at about the glass transition temperature of the part material, or closely below the glass transition temperature, such as within about 15° C., about 10° C., or even about 5° C. below the glass transition temperature).

During the printing operation, belt 722 carries a developed layer 764 of the powder-based, thermoplastic part and/or support materials past pre-sintering heater 768. Pre-sintering heater 768 accordingly sinters the powder-based materials at a high temperature and low (or zero) applied pressure.

In some exemplary embodiments, pre-sintering heater 68 may incorporate a roller arrangement of press roller 768a, backing roller 768b, and heating element 768c. In this embodiment, heating element 768c may heat backing roller 768b to an elevated temperature to heat belt 722 and developed layer 764. Additionally, press roller 768a may apply a low amount of pressure to developed layer 764, such that the combination of the elevated temperature and low amount of applied pressure sinter the powder-based material of developed layer 764 into the sintered contiguous film 764f.

Positioning the heated roller (i.e., backing roller 768b) on the rear side 722b of belt 722 ensures that the belt surface energy will be the dominant sticky surface, as opposed to press roller 768a. Moreover, the surface curvature of belt 722 in the nip of press roller 768a and backing roller 768b also tends to retain the sintered film 764f on belt 722.

Accordingly, this roller embodiment allows sintered film 774 to exit pre-sintering heater 768 at a lower temperature, which correspondingly allows this roller embodiment to be placed closer to nip roller 720 since sintered film 764f will not need as long to cool down to the desired transfer temperature. In addition, because infrared heating is not required for this roller embodiment, the powder-based material may optionally be free of infrared-absorbing materials (e.g., carbon black), allowing different colored pigments and dyes to be incorporated in the composition.

In embodiments of the present invention, heat and simultaneous or subsequent pressure are applied during the transfusion process to Frenkel fuse the developed layers to an intermediate build surface of the 3D structure. The term “Frenkel fused” as used herein means a light tacking or wetting between thermoplastic particles. This can occur at temperatures above Tg, the glass transition temperature, but also at temperatures slightly below the glass transition temperature, because the polymer near a surface has a lower effective glass transition temperature (there is a surface effect that allows the surface to flow more easily). Porosity of a Frenkel fused material is often 10-30%. However, full fusion of the new transfused layer is not yet complete; additional heat must be provided to the part in order fully fuse a new layer onto the previous transfused layers. Past approaches have moderated the heat at the intermediate build surface of a 3D structure as it is built in order to avoid part distortion. Some embodiments of the present invention heat the intermediate build surface to the melt temperature of the thermoplastic prior to layer transfusion, then cool the new intermediate build surface after layer transfusion, recognizing that part distortion can be avoided by controlling the temperature conditions of the layer and transfuse assembly, and by limiting the region of the 3D structure that is super-heated to the transfused layers near the intermediate build surface (termed the “bulk part” layers) By super-heating the top of the intermediate build surface before transfusion of the new layer, heat is supplied to the appropriate region to reach full fusion and build a successful part having properties similar to an injection molded part of the same shape.

The use of a transfer belt as a medium for conveying a layer of material can be challenging due to thermal conditions of the transfuse process, due to belt stretch, quilting, overheating, and underheating. In some instances, the transfusion process can fail, resulting in an incomplete transfer of a developed layer to the build surfaces. In a first instance, which is commonly referred to as “cold offset,” a portion of a developed layer on the transfer medium does not completely transfer from the transfer medium to the build surfaces of the 3D structure due to an insufficient bond between an interface of the developed layer and the build surface. This often occurs due to a lack of heat at the interface between the developed layer and the corresponding intermediate surface. In a second instance, which is commonly referred to as “hot offset,” the bond between a portion of a developed layer and the transfer medium exceeds a bond between the portion and the corresponding build surface. This often occurs when the portion of the developed layer is heated to a degree that it adheres more strongly to the belt than to the adjoining material of the build surface (approaching the Tf). Unfortunately, there is no particular pressure and temperature that can be applied to the developed layers and the build surfaces to ensure that the developed layers vigorously bond to the build surfaces while not bonding strongly to the transfer medium. Embodiments of the present disclosure are directed to electrophotography-based additive manufacturing systems and methods for reducing hot and cold offset transfusion process failures.

FIG. 13 illustrates an exemplary embodiment of a layer transfusion assembly 819. Embodiments of the transfusion assembly 819 include the build platform 870, a pressing component 820, pre-transfusion heaters 872 and 875, and a post-transfusion cooler 876. The build platform 870 is a platform assembly or platen that is configured to receive the heated layers for printing the structure 874, which includes a 3D part formed of the part portions 874p, and an optional support structure formed of the support structure portions 874s, in a layer-by-layer manner. In some embodiments, the build platform 870 may include removable film substrates (not shown) for receiving the printed layers, where the removable film substrates may be restrained against the build platform 870 using any suitable technique (e.g., vacuum, clamping or adhering).

The build platform 870 is supported by a gantry 878, or other suitable mechanism, which is configured to move the build platform 870 along the z-axis and the y-axis, and optionally also along the x-axis that is orthogonal to the y and z axes. The gantry 878 may be operated by a motor 836, based on commands from the controller 24. The motor 836 may be any suitable actuator such an electrical motor, a hydraulic system, a pneumatic system, a piezoelectric device, or the like.

In some embodiments, the gantry 878 is configured to move the build platform 870 along the z-axis and the y-axis. In some such embodiments, the gantry 878 produces a reciprocating rectangular pattern where the primary motion is back-and-forth along the y-axis, as illustrated by broken lines 880 in FIG. 13. While the reciprocating rectangular pattern is illustrated as a rectangular pattern with sharp axial corners, gantry 878 may move the build platform 870 in a reciprocating rectangular pattern having rounded or oval corners, so long as the build platform 870 moves along the y-axis process direction (illustrated by arrow 887a) during the pressing steps at the pressing component 820 described below. The controller 24 controls the gantry 878 to shift the location of an intermediate build surface 876, which is the top surface of the printed structure 874, along the y-axis and position the layers 874p in proper registration with the build surface 876 along the y-axis during the transfusion operation.

In some embodiments, the build platform 870 is heated using a heating element 890 (e.g., an electric heater). The heating element 890 is configured to assist with supplying heat, to achieve a desired bulk part temperature of 3D part 874p and/or support structure 874s, as discussed in Comb et al., U.S. Publication Nos. 2013/0186549 and 2013/0186558. This allows the build platform 870 to assist in maintaining 3D part 874p and/or support structure 874s at this average part temperature.

As shown in FIG. 13, the system or transfusion assembly 819 includes an internally cooled planishing roller 808, prior to the transfer roller 820. Cooled planishing rollers such as roller 808 serve to compact a layer to reduce voids, and reduce the layer temperature to create a film that supports tensile loading and transfer to the part. The porosity of the layer is reduced through this additional pressure and cooling step. Roller 808 presses the layer 822 between itself and the pressing component 820 in this embodiment, but a separate planishing roller 808 and second roller could be used apart from the pressing component 820 without departing from the scope of the disclosure. Whether a layer is planished or unplanished prior to reaching the transfer roller, the temperature of the layer to be transferred, just prior to the transfer roller, is targeted to be at a transfer temperature setpoint.

In some embodiments, the transfer roller 820 is configured to press the layers 822 from the belt to the build surface 876 of the structure 874 to transfuse the layers 822 to the build surface 876. In some embodiments, the transfer roller 820 is configured to press each of the developed layers 822 on the belt 824 or other transfer medium into contact with the build surfaces 876 of the structure 874 on the build platform 870 for a dwell time to form the 3D structure 874 in a layer-by-layer manner.

The pressing component 820 may take on any suitable form. For example, the pressing component 820 as shown is in the form of a transfer roller, as discussed above. The transfer roller can be a compliant transfer roller as described, with either a combination of outer and inner roller materials as discussed with reference to FIG. 6, or made entirely of compliant outer roller material. In some exemplary embodiments, the pressing component 820 includes a pressing plate, such as discussed in Comb et al., in U.S. Pub. Nos. 2013/0186549 and 2013/0075033, which are each incorporated by reference in their entirety. In some exemplary embodiments, the pressing component 820 includes the support of the belt 824 between pairs of rollers, such as discussed in Comb et al., in U.S. Pub. Nos. 2013/0186549 and 2013/0075033. The pressing component 820 may also take on other suitable forms. Thus, while embodiments will be described below using the transfer roller embodiment of the pressing component 820, it is understood that embodiments of the present disclosure include the replacement of the transfer roller with another suitable pressing component 820. The transfer roller is heatable, preferably to a desired transfer temperature which can be established based upon criteria such as materials used.

In some embodiments, the transfer roller 820 is configured to rotate around a fixed axis with the movement of the belt 824. In particular, the transfer roller 820 may roll against the rear surface 824b in the direction of arrow 892, while the belt 824 rotates in the feed direction 832.

In some embodiments, the pressing component 820 includes a heating element 894 (e.g., an electric heater) that is configured to maintain the pressing component 820 at an elevated temperature that is greater than room temperature (25° C.), such as at a desired transfer temperature for the layers 822.

The pre-transfusion heater 872 includes one or more heating devices (e.g., an infrared heater and/or a heated air jet) that are configured to heat the layers 822 on the belt 824 to a temperature near an intended transfer temperature of the layer 822 prior to reaching transfer roller 820. Each layer 822 desirably passes by (or through) the heater 872 for a sufficient residence time to heat the layer 822 to the intended transfer temperature. The pre-transfusion heater 875 may function in the same manner as the heater 872, and heats the top surfaces of the 3D part 874p and any optional support structure 874s on the build platform 870 to an elevated temperature. Pre-transfusion heater 875 provides intense and localized heat to the top surface of the part, which will ultimately be transferred to the newest layer to be transferred. This elevated temperature is a temperature that is higher than a temperature of a layer 822 to be transfused onto the part 874, and of the belt 824. Heater 872 provides heat into the layer 822 to be transferred, so that it may fuse particles of the layer 822 before transfer, and yet be cooler than the part.

Optional post-transfusion cooler 876 is located downstream from transfer roller 820 relative to the direction 887a in which the build platform 870 is moved along the y-axis, and is configured to cool the transfused layers 822. As mentioned above, in some embodiments, prior to building the structure 874 on the build platform 870, the build platform 870 and the transfer roller 820 may be heated to desired temperatures to bring the system to a steady state temperature setpoint more rapidly.

During the printing or transferring operation, the belt 824 carries a layer 822 past the heater 872, which may heat the layer 822 and the associated region of the belt 824 to the transfer temperature. Suitable transfer temperatures for the part and support materials include temperatures that exceed the glass transition temperature of the part and support materials and 66s, where the layer 822 is softened but not melted. The transfer temperature must operate within a window that also insures hot and cold offset do not occur.

During operation, as the gantry 878 moves the build platform 870 along the y-axis in the direction 887a below, along, or through the heater 875, the heater 875 heats the top of the intermediate build surface 876 of the 3D part to a highly elevated temperature. As discussed in Comb et al., U.S. Publication Nos. 2013/0186549 and 2013/0186558, in a prior approach, the heaters 872 and 875 may heat the imaged layer 822 and the intermediate build surface 876 to about the same temperatures to provide a consistent transfusion interface temperature. However, that approach places more reliance on heating of the newly imaged layer, which can cause part shape and belt issues to arise. The strong and rapid application of heat to the top of part before layer transfusion helps to minimize part shape deformation and belt overheating. In some embodiments, the heaters 872 and 875 heat imaged layers 822 and the intermediate build surface 876 to different temperatures to attain a desired transfusion interface temperature. In an embodiment in which heater 875 heats the intermediate build surface 876 to a temperature in excess of the transfer temperature, the part surface functions to conduct heat into the layer 822 that is to be transfused, as well as to the belt 824 and press component 820.

In a transfusion process not using planishing, the layer 822 to be transfused can be heated, for example, to approximately 160° C. This heating may be done using a heater such as heater 872. Such heating is typically performed by heating the layer on a belt 824 to the temperature on the order of 155° C., with the layer having about 15-30% porosity after heating.

In a system not using planishing, the heating of the intermediate part surface to a higher temperature, for example to approximately 260° C., enables a subsequent sharing or heat transfer from the part surface to the layer to be transfused, accelerating and improving the capability to rapidly fuse the new layer. The layer 822 is transfused by pressing the press component 820 against the belt 824 to sandwich the layer 822 between the belt 824 and the part 874. The higher temperature of the part 874 enables heat conduction from the part surface into the layer 822. This, combined with the pressing of press component 820, transfuses the layer 822 to the part 874. After transfusion, the part surface has heated to a temperature above that of the layer 822 entering the transfusion process, and with the transfusion, still has about 15-30% porosity. The tackiness of the layer 822 and pressure from the transfusion process, combined with the surface of the part 874 being heated to a temperature in excess of the layer temperature, allows the heat to conduct to the layer 822 from the part 874 to assist in transfusion at a proper temperature. The heat may be removed after transfusion using a cooler 876.

In a system using planishing, a layer 822 is heated in one embodiment to a temperature on the order of 190° C., for example using a heater 872. Such heating is typically performed by heating the layer on a belt 824 to a temperature on the order of 190° C., the layer having about 30% porosity after heating. Following this, planishing with a cooling roller 808 is used to reduce the porosity of the layer 822 to on the order of 5% to 30%, which also lowers the layer temperature to about 130° C., and the layer 822 is transfused by pressing the press component against the belt 824 to sandwich the layer 822 between the belt 824 and the part 874. In a system not using planishing, the heating of the intermediate part surface, for example to approximately 260° C. or higher, again enables a heat transfer from the part surface to the layer to be transfused.

Regardless of whether planishing is used prior to the transfusion process or not, the approach of preheating the intermediate part surface to a molten state, as opposed to preheating the layer to a molten state, provides a unique approach for avoiding undesirable layer adhesion to the belt, while achieving strong layer to intermediate part surface adhesion through conduction of that applied heat.

In general, the continued rotation of the belt 824 and the movement of the build platform 870 align the heated layer 822 with the heated intermediate build surface 876 of 3D part 874 along the y-axis. The gantry 878 may move the build platform 870 along the y-axis at a rate that is synchronized with the rotational rate of the belt 824 in the feed direction 32 (i.e., the same directions and speed). This causes the rear surface 824b of the belt 824 to rotate around the transfer roller 820 to nip the belt 824 and the heated layer 822 against the intermediate build surfaces 876 at a pressing location or nip of the transfer roller 820. This pressing of the heated layer 822 against the heated intermediate build surface 876 at the location of the transfer roller 820, transfuses a portion of the heated layer 822 below the transfer roller 820 to the corresponding build surfaces 876.

In some embodiments, a pressure that is applied to the layer 822 between the belt 824 and the build surfaces 876 of the 3D structure 874 during this pressing stage of the transfusion process is controlled by the controller 24 through the control of a pressing component roller bias mechanism. The pressing component bias mechanism controls a position of the build surfaces 876 relative to the transfer roller 820 or belt 824 along the z-axis. For instance, when the pressing component 820 is in the form of the transfer roller, as the separation between the build surfaces 876 and the transfer roller 820 or belt 824 is decreased along the z-axis, the pressure applied to the layer 822 increases, and as the separation between the build surfaces 876 and the transfer roller 820 or belt 824 is increased along the z-axis, the pressure applied to the layer 822 decreases. In some embodiments, the pressing component bias mechanism includes the gantry 878 (e.g., z-stage gantry), which controls a position of the build platform 870 and the build surfaces 876 along the z-axis relative to the pressing component 820 and the belt 824. Alternatively, the pressing component bias mechanism may include a lift mechanism that adjusts a positon of the pressing component 820 along the z-axis relative to the build surfaces 876 and the build platform 870. Other suitable pressing component bias mechanisms may also be used.

In various disclosed embodiments, pressure is applied by the pressing component 820 to a portion of the heated layer 822 for a dwell time. The dwell time is affected by the feed rate of the transfer belt 824. The faster the feed rate of the belt 824, the shorter the dwell time. The dwell time is also affected by the transfer roller diameter, the transfer roller durometer, and the pressure profile. To control the dwell time these various factors can be selected or controlled. For example, the durometer of the nip roller can be selected to increase or decrease the dwell time. Alternatively, the controller 24 can change the belt speed or adjust the z-height of the build platform to change the nip pressure.

In some embodiments, a single pass dwell time is on the order of 100× too short to result in full sintering. Active belt cooling can be used to counteract the temperature diffusion from the top of part to the belt/layer interface, allowing a greater maximum dwell time.

The dwell time is also affected by a durometer of the belt 824 and/or the pressing component 820. The softer the durometer, the greater the length of the surface of the transfer layer 822 over which the pressure is applied by the pressing component.

The peak pressure also affects the dwell time of the pressing component 820. For example, as the pressure increases, the belt 824 and exterior surface of the transfer roller flatten and extend the length of the surface of the layer 822 that is pressed by the transfer roller 820 and belt 824. As the pressure decreases, the length of the surface of the layer 822 that is pressed by the transfer roller 820 and belt 824 is reduced.

After the dwell time is completed, such as after the transfused layer 822 passes the nip of the transfuse roller 820, the belt 824 disengages from the build platform 870. Ideally, the transfused layer 822 releases from the belt 824 and remains adhered to the build surfaces 876 of the 3D structure 874. After release, the gantry 878 continues to move the build platform 870 along the y-axis to the post-transfusion cooler 876. At the post-transfusion cooler 876, the new intermediate build surface 876 (including the transfused layer 822) may then be cooled.

In some embodiments, the transfusion assembly 819 includes one or more cooling units (not shown) downstream from the transfuse roller 820 relative to the direction 887a, which operate to cool the structure 874. Thus, as the gantry 878 moves the build platform 870 along the y-axis past the post-transfusion cooler 876, which may comprise blowers, to actively cool the top transfused layers 822 down to the average part temperature, such as discussed in Comb et al., U.S. Publication Nos. 2013/0186549 and 2013/0186558.

To assist in keeping the 3D part hotter than the bulk part temperature, the heater 875 may be configured to heat only the top-most layers of 3D part. In embodiments in which heaters 872 and 875 are configured to emit infrared radiation, the 3D part may include heat absorbers and/or other colorants configured to restrict penetration of the infrared wavelengths to within the top-most layers. Alternatively, the heaters 872 and 875 may be configured to blow heated air across the top surface of 3D part. In either case, limiting thermal penetration into 3D part allows the top-most layers to become sufficiently fused, while maintaining lower layers of 3D part at the bulk part temperature or cooler. Heating the intermediate part surface hotter than the bulk part temperature propagates heat into the top-most layers of the part, promoting fusion of the particles in previously transferred layers, and in addition heats and promotes fusion in the new layer being transferred to the part.

The gantry 878 may then actuate the build platform 870 downward, and move the build platform 870 back along the y-axis to a starting position along the y-axis, following the reciprocating rectangular pattern 880. The build platform 870 desirably reaches the starting position, and the build surfaces 876 are properly registered with the next layer 822 using the gantry 878. The same process may then be repeated for each remaining layer 822 of 3D part.

Although the present disclosure has been described with reference to preferred embodiments, workers skilled in the art will recognize that changes may be made in form and detail without departing from the spirit and scope of the disclosure.

1. A selective deposition-based additive manufacturing system for printing a three-dimensional part, the additive manufacturing system comprising:
an electrostatographic imaging engine configured to develop an imaged layer of a thermoplastic-based powder;
a movable build platform;
a transfer medium configured to receive the imaged layer from the imaging engine, and to convey the received imaged layer;
a first heater configured to heat the imaged layer; and
a transfusion element configured to transfer the heated imaged layer conveyed by the transfer medium onto the movable build platform by pressing the heated imaged layer between the transfer medium and the moveable build platform, the transfusion element comprising a compliant nip roller configured to deform when in contact with previously transferred layers of the part.

2. The selective deposition-based additive manufacturing system of claim 1, and further comprising a cooling unit configured to actively cool the transferred layer.

3. The selective deposition-based additive manufacturing system of claim 1, and further comprising a second heater configured to pre-heat at least a portion of the part being printed on the moveable build platform.

4. The selective deposition-based additive manufacturing system of claim 1, and further comprising a second heater configured to post-heat the transferred layer.

5. The selective deposition-based additive manufacturing system of claim 1, wherein the compliant nip roller comprises an outer roller material providing an outer contact surface, the outer roller material having a Shore hardness of less than 60 Shore A.

6. The selective deposition-based additive manufacturing system of claim 5, wherein the outer roller material has a Shore hardness of between 20 Shore A and 50 Shore A.

7. The selective deposition-based additive manufacturing system of claim 5, wherein the outer roller material comprises silicon rubber.

8. The selective deposition-based additive manufacturing system of claim 5, and wherein the compliant nip roller further comprises an inner roller material covered by the outer roller material.

9. The selective deposition-based additive manufacturing system of claim 8, wherein the outer roller material has a thickness of between 0.1 inch and 0.5 inch.

10. The selective deposition-based additive manufacturing system of claim 1, wherein the transfer medium comprises a rotatable belt.

11. The selective deposition-based additive manufacturing system of claim 10, wherein the moveable build platform is configured to move in a reciprocating rectangular pattern that is synchronized with a rotation of the rotatable belt.

12. The selective deposition-based additive manufacturing system of claim 10, wherein the compliant nip roller is configured to press the heated imaged layer between the transfer medium and the build platform for a dwell time.

13. The selective deposition-based additive manufacturing system of claim 12, wherein the dwell time is about 0.1 to 5.0 times a thermal diffusion time through a thickness of each of the developed layers.

14. The selective deposition-based additive manufacturing system of claim 12, and further comprising a controller configured to control the dwell time by controlling at least one of a speed of the belt, a height of the build platform, and a nip pressure.

15. A selective deposition-based additive manufacturing system for printing a three-dimensional part, the additive manufacturing system comprising:
an imaging engine configured to develop imaged layers of a thermoplastic-based powder;
a movable build platform;
a rotatable belt having a transfer surface and an opposing contact surface, wherein the transfer surface is configured to receive the imaged layers from the imaging engine in a successive manner, and to convey the received image layers to the build platform in a successive manner;
a first heater configured to heat the imaged layers on the transfer surface in a successive manner;
a nip roller configured to transfuse the heated imaged layers conveyed by the transfer medium in a successive manner onto the movable build platform by engaging and rolling across the contact surface of the rotatable belt, the nip roller configured to deform when pressing the heated imaged layers to reduce deformation of the heated imaged layers;
a cooling unit configured to actively cool the transfused layers in a successive manner.

16. The selective deposition-based additive manufacturing system of claim 15, wherein the nip roller comprises an outer roller material providing an outer contact surface, the outer roller material having a Shore hardness of less than 60 Shore A.

17. The selective deposition-based additive manufacturing system of claim 16, wherein the outer roller material has a Shore hardness of between 20 Shore A and 50 Shore A.

18. The selective deposition-based additive manufacturing system of claim 16, wherein the outer roller material comprises silicon rubber.

19. The selective deposition-based additive manufacturing system of claim 16, and wherein the compliant nip roller further comprises an inner roller material covered by the outer roller material, the inner roller material having a higher Shore hardness than the outer roller material.

20. The selective deposition-based additive manufacturing system of claim 19, wherein the outer roller material has a thickness of between 0.1 inch and 0.5 inch.
